(19) United States
(12) Patent Application Publication
(10) Pub. No.: US 2005/0138464 A1
(43) Pub. Date: Jun. 23, 2005

(54) Scratch fill using scratch tracking table

(76) Inventors: PohSoon Chong, Singapore (SG); Kumanan Ramaswamy, Singapore (SG); Long Zhao, Singapore (SG)

Correspondence Address: Seagate Technology LLC, 1280 Disc Drive, Shakopee, MN, 55379, US

(21) Appl. No.: 10/719,606

(22) Filed: Nov. 21, 2003

(51) Int. Cl. G06F 11/00

(52) U.S. Cl. 714/5

(57) ABSTRACT

A method and system of managing spatially related defects on a data storage media surface in a data storage device includes operations of identifying defect locations on the media surface, determining whether the location of an identified defect is within a predetermined window of another identified defect location on the media surface, if the location is within the predetermined window, characterizing the defects in the window as a scratch. A scratch-tracking table is then generated having a unique entry for each scratch and a start index and an end index for each scratch. Also, a scratch index table is generated that lists each and every defect location on the media along with its defect index and the scratch index associating the particular defect with an identified scratch. These two tables are then utilized to pad the scratches. A variant of the method includes iteratively processing through caches in the event that limited buffer memory is available to the device controller or large numbers of defect locations are identified during certification testing.

### FIELD OF THE INVENTION

This application relates generally to data storage devices and more particularly to a method and system for efficient management of defects on a data storage medium in a data storage device such as a disc drive.

### BACKGROUND OF THE INVENTION

In the field of storage medium defect management, various methods have been utilized to handle defects. Some of these defects may be isolated occurrences on the media. Others may be characterized as scratches. A scratch, as used in this application, is a line of defects on the storage media where data cannot be properly stored and recovered. They are usually caused by some process during manufacture, or handling, and may be continuous or may have breaks in-between. Process and/or reliability problems may be encountered when such scratches grow, i.e. are extended, during normal drive operation. One method utilized for handling potentially large defects such as scratches in the recording medium surface, is called “scratch fill.” One scratch fill method is described in detail in co-pending application Ser. No. 10/003,459, filed Oct. 31, 2001.

Scratch fill algorithms basically look at the defects identified on the media and fill in gaps between closely spaced defects as these typically are indicative of continuous scratches in the media surface. This process is one method that attempts to anticipate where defects that are passed over during generation of the defect list are likely to occur and essentially fill in the gaps, as well as pad the identified defects. During drive operation, a substantial amount of processing time is utilized in processing data through the defect management algorithms. In addition, there is a potential for the defect list to become full during the scratch fill process as well as failing due to improperly fill due to limitations in the algorithms. In short, such problems may cause the microprocessor to simply run out of memory during the scratch fill process.

Accordingly there is a need for a robust and efficient method of handling and processing scratches, and handling data that includes fast processing and accessing of defect lists so that minimal processing time is needed for such checks. The present invention provides a solution to this and other problems, and offers other advantages over the prior art.

### SUMMARY OF THE INVENTION

Against this backdrop the present invention has been developed. An embodiment of the present invention to reduce the processing time is to load and utilize part of the Primary Defect List (PDL) into fast cache memory or Static Random Access Memory (SRAM). Another scheme may use the Synchronous Dynamic Random Access Memory (SDRAM). In both cases, defect tracking tables are utilized to track the scratches and the buffer memory is used to complement that used by the microcontroller. This results in reduced processing time and elimination of the problem of overloading the available memory.

A method of managing spatially related defects on a data storage media surface in a data storage device in accordance with an embodiment of the present invention includes operations of identifying defect locations on the media surface, determining whether the location of an identified defect is within a predetermined window of another identified defect location on the media surface, if the location is within the predetermined window, characterizing the defects in the window as a scratch. A scratch-tracking table is then generated having a start index and an end index for each scratch. Also, a scratch index table is generated that lists each and every defect location along with its defect index and the scratch index associating the particular defect with an identified scratch. These two tables are then utilized to pad the scratches as well as being utilized in a buffer during drive operation to facilitate efficient defect location identification when queried by the controller of the data storage device. Another embodiment of the present invention utilizes one or more caches to iteratively develop and process the scratch tracking table and scratch index tables as well as develop the padding of the defects in the event that limited memory is available for use.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components.

FIG. 2 is a schematic block diagram of a disc drive control system utilized in control of the disc drive shown in FIG. 1.

FIG. 3 is a basic overall process flow diagram of the method of handling scratches in accordance with a preferred embodiment of the present invention.

FIG. 4 is an illustration of an exemplary portion of a scratch tracking table in accordance with a preferred embodiment of the present invention.

FIG. 5 is an illustration of an exemplary portion of a primary defect list scratch index table associated with the scratch-tracking table shown in FIG. 4.

FIG. 6 is a process flow diagram of a routine that generates the tables shown in FIGS. 4 and 5.

FIG. 7 is a further exemplary illustration of a scratch tracking table (STT) in accordance with a preferred embodiment of the present invention.

FIG. 8 is a further exemplary illustration of a primary defect list scratch index (PSI) table associated with the scratch tracking table shown in FIG. 7.

FIG. 9 is a process flow diagram of the routine that generates the scratch padding in accordance with the present invention.

FIG. 10 illustrates portions the Scratch Tracking Table and P-List Scratch Index table with associated padding of exemplary Scratch 9.

FIG. 11 is a process flow diagram of a routine that generates the STT and PSI tables in accordance with the present invention in which a cache is utilized for both the P-List and the PSI table.

FIG. 12 is a process flow diagram of a routine that generates the STT and PSI tables in accordance with an embodiment of the present invention in which a cache is utilized for the STT.

FIG. 13 is a process flow diagram of a routine that pads the defect scratches identified with caching for STT.

FIG. 14 is a process flow diagram of a routine that is utilized when the PSI table is larger than the size of a buffer space allocated for the PSI table

### DETAILED DESCRIPTION

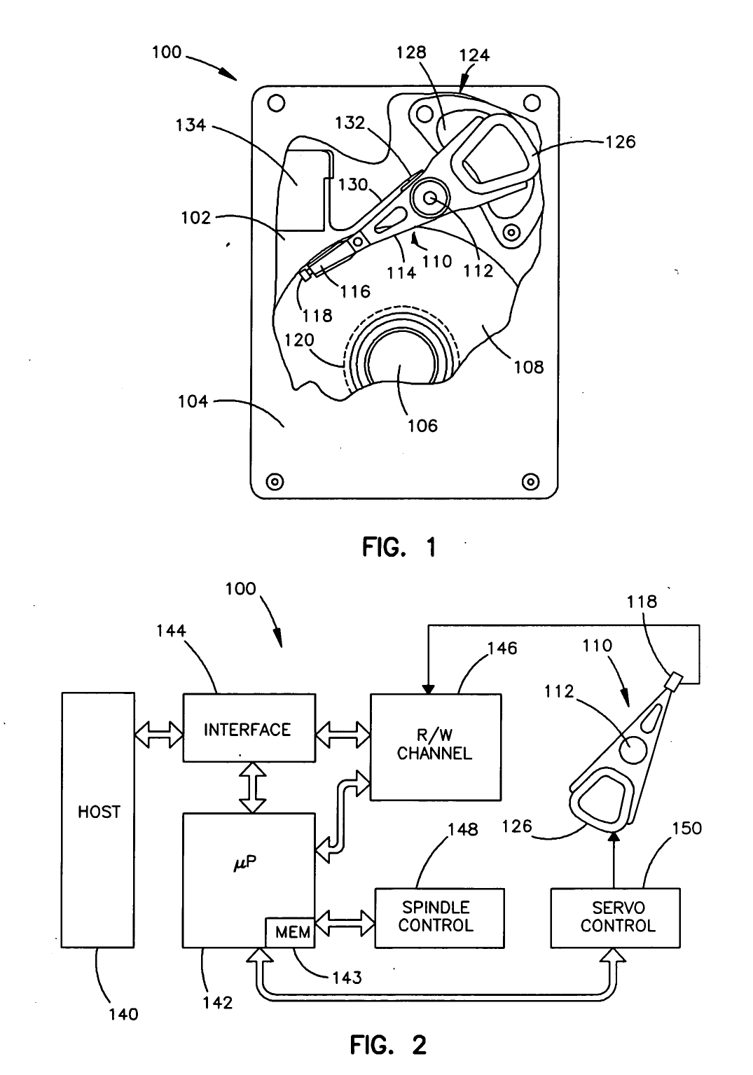

A disc drive 100 that incorporates a preferred embodiment of the present invention is shown in FIG. 1. The disc drive 100 includes abase 102 to which various components of the disc drive 100 are mounted. A top cover 104, shown partially cut away, cooperates with the base 102 to form an internal, sealed environment for the disc drive in a conventional manner. The components include a spindle motor 106 that rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118, which includes a fluid bearing slider, enabling the head 118 to fly in close proximity above the corresponding surface of the associated disc 108.

During a seek operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are moved over park zones 120 near the inner diameter of the discs 108 when the drive motor is de-energized. The heads 118 are secured over the park zones 120 through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation; The flex assembly terminates at a flex bracket 134 for communication through the base deck 102 to a disc drive printed circuit board (not shown) mounted to the bottom side of the disc drive 100.

Referring now to FIG. 2, shown therein is a basic functional block diagram of the disc drive 100 of FIG. 1, generally showing the main functional circuits which are resident on the disc drive printed circuit board and used to control the operation of the disc drive 100. The disc drive 100 is operably connected to a host computer 140 in a conventional manner. Control communication paths are provided between the host computer 140 and a disc drive microprocessor 142, the microprocessor 142 generally providing top level communication and control for the disc drive 100 in conjunction with programming for the microprocessor 142 stored in microprocessor memory (MEM) 143. The MEM 143 can include random access memory (RAM), read only memory (ROM) and other sources of resident memory for the microprocessor 142.

The discs 108 are rotated at a constant high speed by a spindle motor control circuit 148, which typically electrically commutates the spindle motor 106 (FIG. 1) through the use of back electromotive force (BEMF) sensing. During a seek operation, wherein the actuator 110 moves the heads 118 between tracks, the position of the heads 118 is controlled through the application of current to the coil 126 of the voice coil motor 124. A servo control circuit 150 provides such control. During a seek operation the microprocessor 142 receives information regarding the velocity of the head 118, and uses that information in conjunction with a velocity profile stored in memory 143 to communicate with the servo control circuit 150, which will apply a controlled amount of current to the voice coil motor coil 126, thereby causing the actuator assembly 110 to be pivoted.

Data is transferred between the host computer 140 or other device and the disc drive 100 by way of an interface 144, which typically includes a buffer to facilitate high-speed data transfer between the host computer 140 or other device and the disc drive 100. Data to be written to the disc drive 100 is thus passed from the host computer 140 to the interface 144 and then to a read/write channel 146, which encodes and serializes the data and provides the requisite write current signals to the heads 118. To retrieve data that has been previously stored in the disc drive 100, read signals are generated by the heads 118 and provided to the read/write channel 146, which performs decoding and error detection and correction operations and outputs the retrieved data to the interface 144 for subsequent transfer to the host computer 140 or other device.

Throughout this specification a number of abbreviations are used that require short definitions. They are as follows:

SRAM: Static Dynamic Random Access Memory

SDRAM: Synchronous Dynamic Random Access Memory

DRAM: Dynamic Random Access Memory.

TCM: Tightly Coupled Memory.

P-List: Primary Defect List (PDL). This is a list of all data defects.

P-List Cache Table: This table is a cache to hold the P-List entries from the SDRAM during data processing.

PSFT: Primary Servo Flaw Table. This is a table tracking location of all servo defects.

TA List: Thermal Asperities List. This list contains all identified thermal asperities.

STT: Scratch-Tracking Table. This table contains one entry for each scratch identified. The STT stores the index of the entries in the P-List and other information.

PSI: P-List Scratch Index. The PSI is a table having an entry for every P-List entry and each of the 2-byte entry record for the STT index that the P-List entry has been associated with. In other words, the PSI stores the STT index that the corresponding P-List entries belong to.

BFI: Bytes From Index. This is the distance on a track from the index mark to the defect location.

Len: Length of the defect.

In a disc drive data storage device, any defects on the magnetic media fall into one of three categories: data defects, servo defects, and thermal asperities. All identified data defects are kept in the P-List. All servo defects are kept in the PSFT. All thermal asperities identified are kept in the TA list. Both the P-List and the PSFT undergo scratch fill processing. In addition, the defects in the PSFT and TA list are folded in to the P-List at the end of the certification testing prior to release of the drive from production.

A scratch is typically recognized and identified as such if two defects are detected within a predetermined radial and circumferential window. As an example, a typical window may be 500 bytes circumferentially and 130 cylinders radially. Thus, if two defects are identified in this area they will be characterized as a scratch.

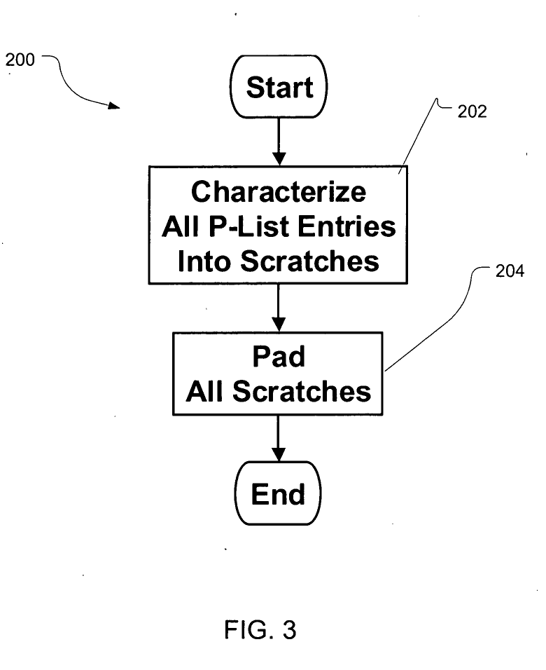

A basic two-step scratch fill process 200 in accordance with an embodiment of the present invention is shown in FIG. 3. Scratch fill begins in operation 202 where the entries in the P-list are classified into different scratches. Each entry in the P-List is evaluated to determine whether it falls within the scratch definition window such as mentioned above. Once the entire P-List has been analyzed, control transfers to operation 204, where padding of each of the scratches takes place. The padding operation 204 basically adds bytes called “pad defect entries” at either end of the scratch and fills in the middle portion of the identified scratch. Control then transfers to end operation 206.

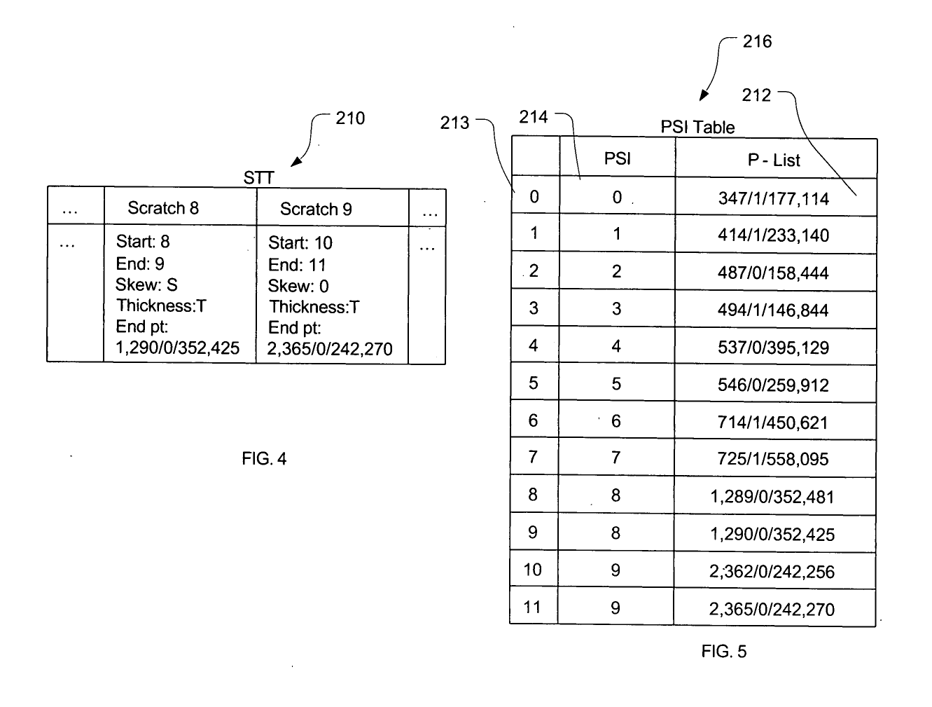

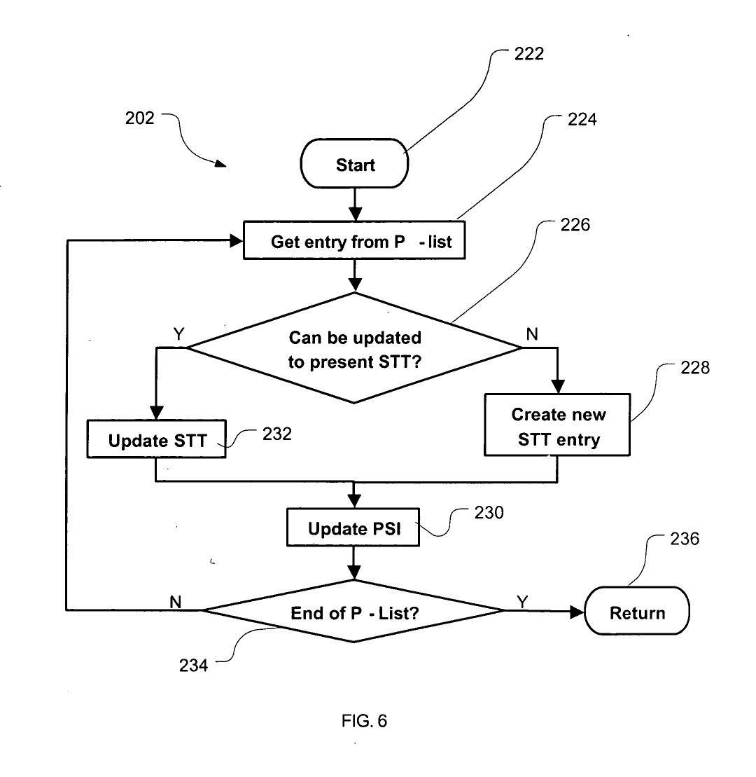

Next, a Scratch Tracking Table 210, two entries of which are shown in FIG. 4, is generated and updated for each entry in the P-list utilizing the process operations 220 shown in FIG. 6. In parallel, a P-list Status Index (PSI) table 216 is generated. A portion of the PSI table 216 is illustrated in FIG. 5. The PSI table 216 associates each P-list entry 212 with the STT 210 and requires 2 bytes for each PSI entry 214. Thus there is one PSI entry 214 for every P-list entry 212 and each is a 2-byte entry record. The PSI table 216 is maintained in DRAM, and includes 1024 entries in a cache.

The scratch tracking table (STT) 210 has one entry per scratch. Each entry lists a number of properties of the identified scratch: Start index 213 (index number associated with the P-list entry 212), end index (from the P-list), skew, thickness, end point, and other properties not pertinent to this discussion. Two entries in the STT are shown in FIG. 4. Shown are two scratch entries 8 and 9.

FIG. 5 shows an exemplary portion of a PSI table 216. Note that in this figure, each of the scratches with PSI of 0 through 7 corresponds to single defects and therefore the PSI table entry index number 213 (left column) and the PSI value 214 (center column) are the same. This circumstance is purely coincidental in this simplified example. Since these defects do not form a scratch with any priorentries, they are assigned to different scratch numbers. Referring to FIG. 5, Scratch No. 8, begins at cylinder 1289, head 0 and BFI of 352,481 and ends at cylinder 1290, head 0, and BFI of 352,425. Similarly, Scratch Number 9 begins at cylinder 2362, head 0, and BFI of 242,256. Scratch Number 9 ends at cylinder 2365, head 0 and BFI of 242,270.

The operational flow diagram of the process 202 of characterizing the scratches on the disc is shown in FIG. 6. Process 202 begins in start operation 222 upon the completion of generation of the P-list. Control then transfers to operation 224.

Operation 224 loads a first entry from the P-List. Control then transfers to query operation 226 that asks whether the loaded P-list entry fits the scratch size window of any of the last P-List entry of the existing STT scratch entries, and thus can be classified in the current STT entries. In other words, this query operation examines whether the loaded P-List entry fits the criteria defining the scratch window. As mentioned above, a typical predetermined radial and circumferential window may be 500 bytes circumferentially and 130 cylinders radially. Thus, if the current defect is identified as falling into such an area encompassing the last defect of any STT entry, both entries will form a scratch or part of a scratch. If the answer is no, control transfers to operation 228. In operation 228, a new STT entry is created for the loaded P-list entry, as the defect is not part of an identified scratch at this point. Control then transfers to operation 230.

If the answer in query operation 226 is yes, control transfers to operation 232. Here the relevant STT entry is updated to the loaded P-list entry value. This, in essence, identifies the defect as part of the scratch identified in the relevant STT entry. Control then transfers to operation 230.

Control operation 230 updates the PSI entry 214 (i.e. the scratch number) of the P-List entry 212 in the PSI table 216 and then transfers to query operation 234. Operation 234 checks whether the operation has reached the end of the P-List and, if the answer is yes, control transfers to end operation 236 and process control returns to the host. If on the other hand, the answer is no, there are more P-List entries, then control transfers back to operation 224 where a next P-List entry is loaded, and operations 224 through 234 are repeated until the last P-list entry is processed. In this manner, the STT 210 and PSI table 216 are both generated.

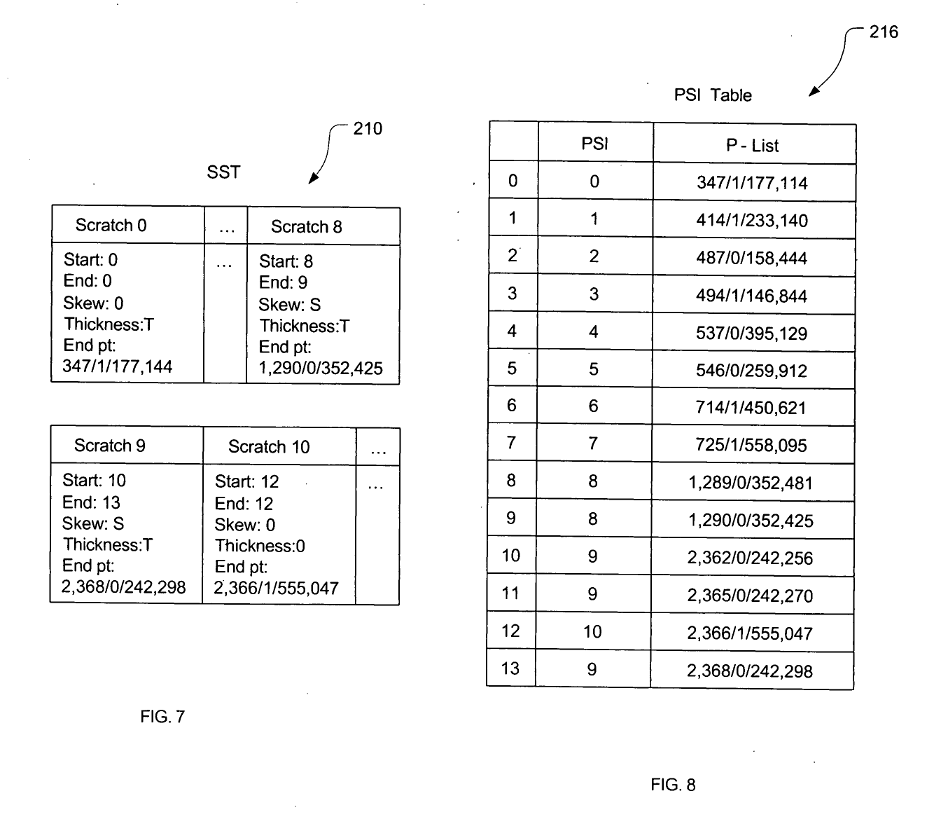

FIGS. 7 and 8 illustrate this process 202 in action in more detail. FIG. 7 shows four scratches, Nos. 0, 8, 9 and 10 as illustrative examples. Since, during the first time through the routine, in operation 224, there are no entries in the STT 210, the process takes the first entry through query operation 226, in which the answer is no, and goes to operation 228, in which a new entry is created that starts with index 0. The start and end index will be 0 at this point. The defect location information, 347/1/177,144 are thus inserted in the STT 210 for Scratch No. 0 as the end point in operation 228. The PSI value of 0 is entered in the PSI table 216 in operation 230. The identical steps described above, i.e. operations 224, 226, 228, and 230 are repeated for the next 7 entries since they do not form scratches with any other points in the P-list, and thus new STT entries are generated, rather than prior entries updated.

Entry indices 8 and 9 of the P-List, however, actually do form a scratch. First, the corresponding information for index 8, as in index 0, is copied to entry 8 of the STT. The end point of Scratch 8 initially will be 1,289/0/352,381 in operation 228. Then, when index 9 of the P-List is processed through operation 224 to operation 226, i.e., the P-List entry for index 9 is checked against the endpoint of the previous STT 210 entries, it meets the criteria to be a part of Scratch 8. Thus the answer to the query in operation 226 is yes. Control then transfers to operation 232. The STT 210 entry for Scratch No. 8 is updated to end at index 9, and the ending point is updated to 1,290/0/352,425. Thus the STT 210 and PSI table 216 are updated with the relevant information with scratch 8 ending at P-list entry 9, as is also shown in FIG. 4.

Now, note that in the PSI table 216 in FIG. 8, P-list entries 10, 11, and 13 are all very closely related on head 0. They are all thus within a window and are part of a scratch number 9. Indices 10 and 11 are processed the same way as 8 and 9 discussed above. Their information is stored under Scratch No. 9 in STT 210.

In particular, the sequence is as follows. P-List entry 10 is loaded in operation 224. Control transfers to query operation 226, where the entry is compared to the previous P-List entries to see if it fits within the window for a scratch. As it does not, control transfers to operation 228, where Scratch No. 9 entry is made in the STT 210, with start and end values of 10, and end point of 2,362/0/242,256. Control transfers to operation 230, where the PSI for entry 10 is updated to reflect Scratch No. 9. Control then returns to operations 224 and 226 for P-List entry 11. As the P-List entry 11 is within the window, control transfers to operation 232 where the end value is updated to P-List entry 11 and the end point is updated to 2,365/0/242,270. Control then transfers to operation 230, where the PSI for entry 11 is set at 9.

Control then passes to operation 234, thence back to operation 224, where P-List index No. 12 defect is loaded. Control then transfers to operation 226, where the P-List entry is compared again to the prior entries. This entry is not within the window, so control transfers to operation 228, where a new entry 10 is assigned in the STT 210. The start value and end value are set at the P-List entry index of 12, and the end point is set at 2,366/1/555,047.

Control then passes through query operation 234 again to operation 224 where P-List entry 13 is loaded. In operation 226, this entry is compared to the prior P-List entries and found to be within the window of Scratch No. 9. Thus control transfers to operation 232. Here, the scratch start value remains the same, but the end value is now updated to 13. The end point is also updated to 2,368/0/242,298. Control then passes to operation 234, and, for this example, assuming there are no more entries in the P-List, transfers to end operation 236, which essentially passes control back to operation 204 in the process 200 shown in FIG. 3.

The above process illustrates that, as each P-List entry is evaluated, the STT 210 is appended to or updated until all P-List entries have been tested against the window criteria for a scratch. This completes the first phase of the process in accordance with the present invention, involving characterization of the defects in the P-List 212.

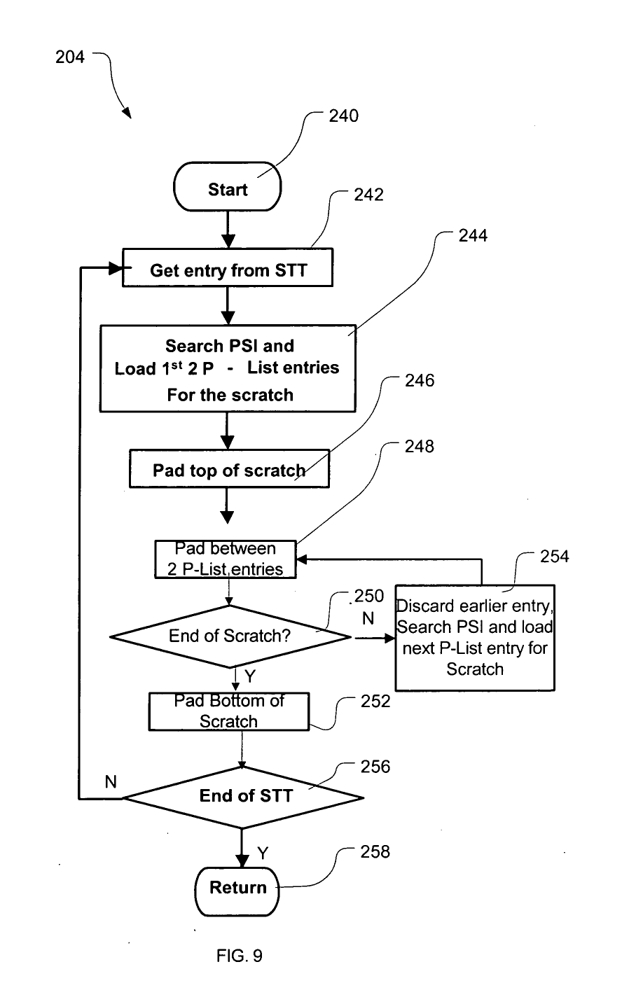

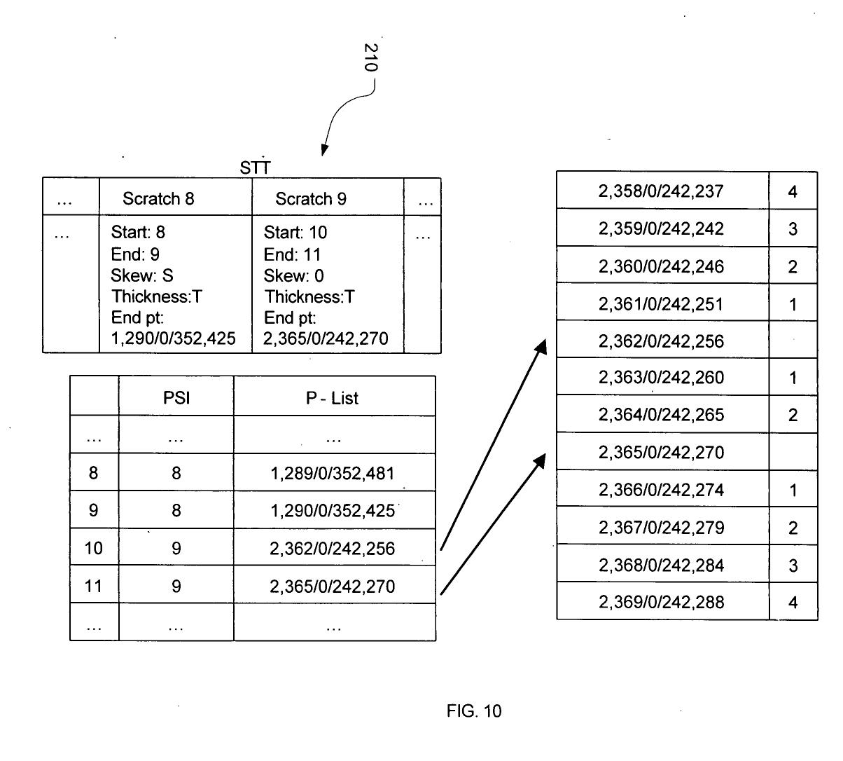

Operation sequence 204, of padding all the identified scratches in the STT 210, will now be described with reference to FIGS. 9 and 10. Padding of the identified scratches is performed in sequence, starting at the top and working down to the end of the STT 210 via the operational sequence 204 shown in FIG. 9. Sequence or routine 204 begins in start operation 240 which initializes counters and registers. Control then passes to operation 242 where the first scratch, Scratch No. 0, in STT 210 is loaded. The Control then transfers to operation 244.

Recall from FIG. 7, that Scratch No. 0 includes only one defect. This is merely coincidental, as discussed above. In operation 244, the PSI table 216 is searched to identify another P-List entry 212 associated with Scratch No. 0. Since there is only one, control then transfers to operation 246, where the top of the one defect scratch is padded. The length of the defect is compared against a length parameter set by the user. If the defect length exceeds the value set, a pad of similar length will be added one cylinder above and below the defect. If the defect length equals or is less than the value set, a pad defect entry of the value set by the user is added above and below the defect. Thus the total “tail” size, i.e., the pad at either end of the scratch, in the radial direction, is determined by the user. Control then transfers to operation 248 where a pad is established between the 2 P-List entries. However, in Scratch 0 there is no second P-List entry, therefore control simply passes to query operation 250, which asks whether the end of the scratch has been reached. In the case of Scratch 0, the answer is yes, and control transfers to operation 252, where the bottom of the single defect scratch of Scratch 0 is padded in a manner as above described in operation 246. Control then transfers to query operation 256. Query operation 256 asks whether the end of the STT has been reached. In this case, the answer is no, and control transfers back to operation 242, where the next entry from the STT is loaded. The sequence of operations 242, 244, 246, 248, 250, 252, and 256 are then repeated, in the example described and shown in FIGS. 7 and 8, for Scratches 1 through 7.

Then, for Scratch No. 8, the STT entry is loaded in operation 242. Control passes to operation 244 where the PSI is searched for the next P-List entry associated with Scratch No. 8 and loaded. Control then passes to operation 246, where the top of Scratch No. 8 is padded. Again, the length of the defect is compared against a length parameter set by the user. If the defect length exceeds the value set, a pad of similar length will be added one cylinder above and below the defect. If the defect length equals or is less than the value set, a pad defect entry of the value set by the user is added above and below the defect. Thus the total “tail” size, i.e., the pad at either end of the scratch, in the radial direction, is determined by the user. Control then transfers to operation 248 where a pad is established between the 2 P-List entries. Control then transfers to query operation 250 which asks whether the end of the scratch has been reached. In this case, the answer is yes, so control passes to operation 252 where the bottom of the scratch is padded as previously described. Control then passes to query operation 256 which asks whether the end of the STT has been reached. The answer is no, so control passes back to operation 242 and the next entry, Scratch No. 9, is loaded.

The column on the right side of FIG. 10 indicates the sequence of pad addition made to the Scratch No. 9, between defects 2,362/0/242,256 and 2,365/0/242,270. The example illustrated in FIG. 10 is four cylinders in the radial direction for illustrative purposes. This could be as much as 20 or 30 cylinders.

Control passes to operation 244 where the PSI is searched for the next P-List entry associated with Scratch No. 9 and this second entry is loaded. Control then passes to operation 246, where the top of Scratch No. 9 is padded. As shown in FIG. 10, the padding is four cylinders above. Control then transfers to operation 248 where a pad is established between the 2 P-List entries. In this case, two pad entries are made. Control then transfers to query operation 250 which asks whether the end of the scratch has been reached. In the example shown in FIG. 10, the answer is yes, so control passes to operation 252 where the bottom of the scratch is padded as previously described.

However, if the example of Scratch No. 9 as shown in FIGS. 7 and 8 were encountered, where there is another PSI entry associated with Scratch No. 9, the answer to query operation 250 would have been no. In that case, control would transfer to operation 254. In operation 254, the earlier of the pair of entries previously loaded in operation 244 is discarded and replaced with the next P-List entry for the scratch. In the case of FIGS. 7 and 8, that would be index 13, (2368/0/242,298). Control then passes to operation 248 where padding is done between the two loaded entries. For scratches that have a larger number of defects identified, this sequence, of operations 248, 250, 254 are repeated until the answer in query operation 250 is yes. Control then transfers to operation 252, where the bottom of the scratch is padded as described above. Control then passes to query operation 256, which asks whether the end of the STT has been reached. If the answer is now yes, control transfers to return operation 258, where control returns to the calling program.

In summary, in the example shown in FIG. 10, first, four pad defect entries are added above the scratch defect, i.e., one on each of the four cylinders immediately prior to the start cylinder of the defect (physically, on one side of the defect). Second, a pad defect entry is added to the two cylinders between the start and end cylinders. Third, four pad defect entries are added following the end of the scratch, i.e. one on each of the four cylinders immediately after the end cylinder of the defect (i.e., physically on the other side of the end defect). The BFI number is just the quantum space to be added or subtracted to each preceding or subsequent pad entry. It can be obtained by the difference of the two defect points divided by the number of cylinders in between. In the illustrated example, the difference is 14 and the number of cylinders in between is 3. Similarly, there is padding done in the circumferential direction that is not illustrated in the example shown in FIG. 10.

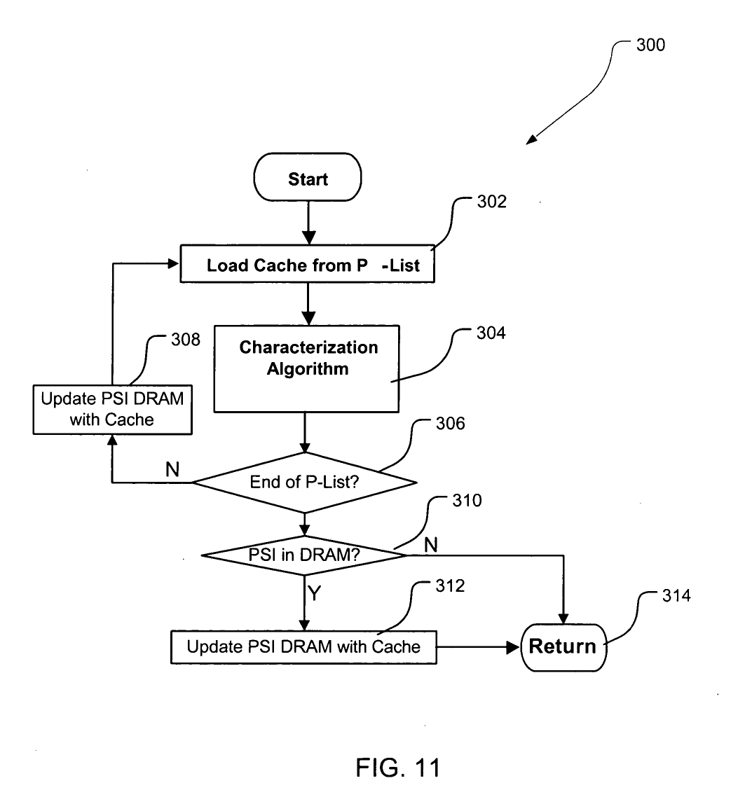

An alternative method in accordance with an embodiment of the present invention is utilized when dealing with a drive configuration that includes limited Tightly Controlled Memory (TCM). In this case, caching schemes are incorporated into the method 200 of characterizing (202) and padding (204) scratches. This method is shown in FIGS. 11 through 14.

TCM currently incorporates only 1024 entries of PSI (2 bytes each entry), 1024 entries of P-List (14 bytes each entry) and 256 entries of STT (48 bytes each). Consequently, a caching scheme must be employed, in which scratch characterization is done in blocks of 1024 entries and padding is done using the PSI, with only selected entries being retrieved. This is facilitated because each P-List entry belongs to only one scratch. One of the advantages of using the PSI, is that it facilitates quick update and retrieval since it only utilizes 2 bytes per entry.

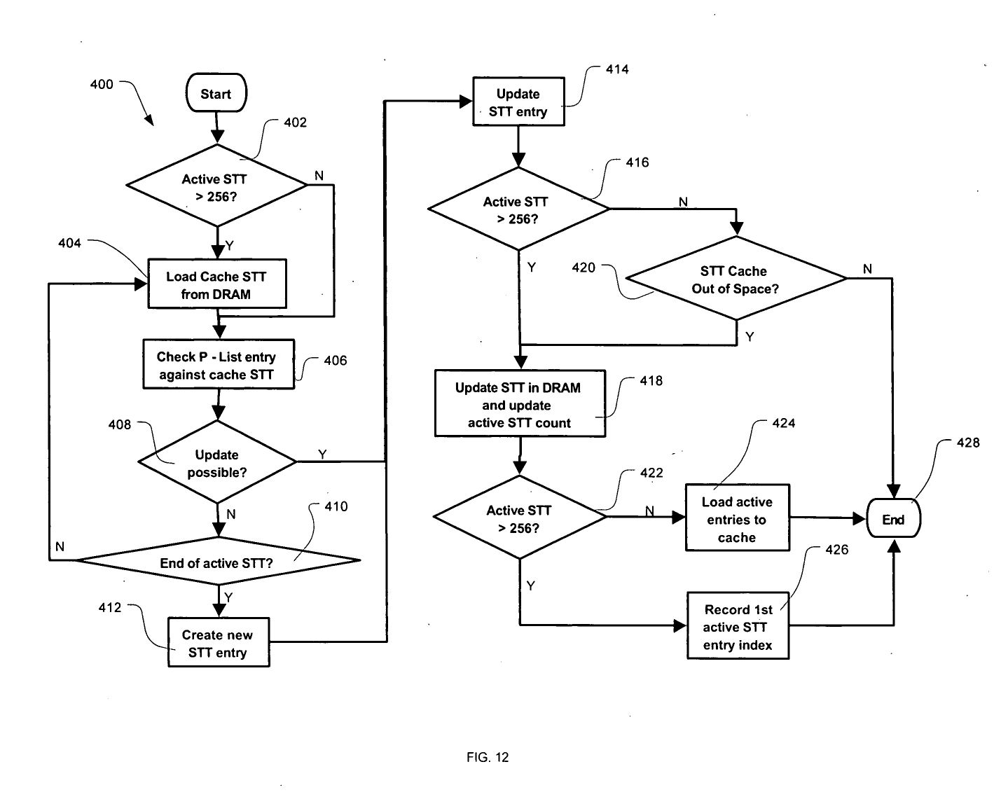

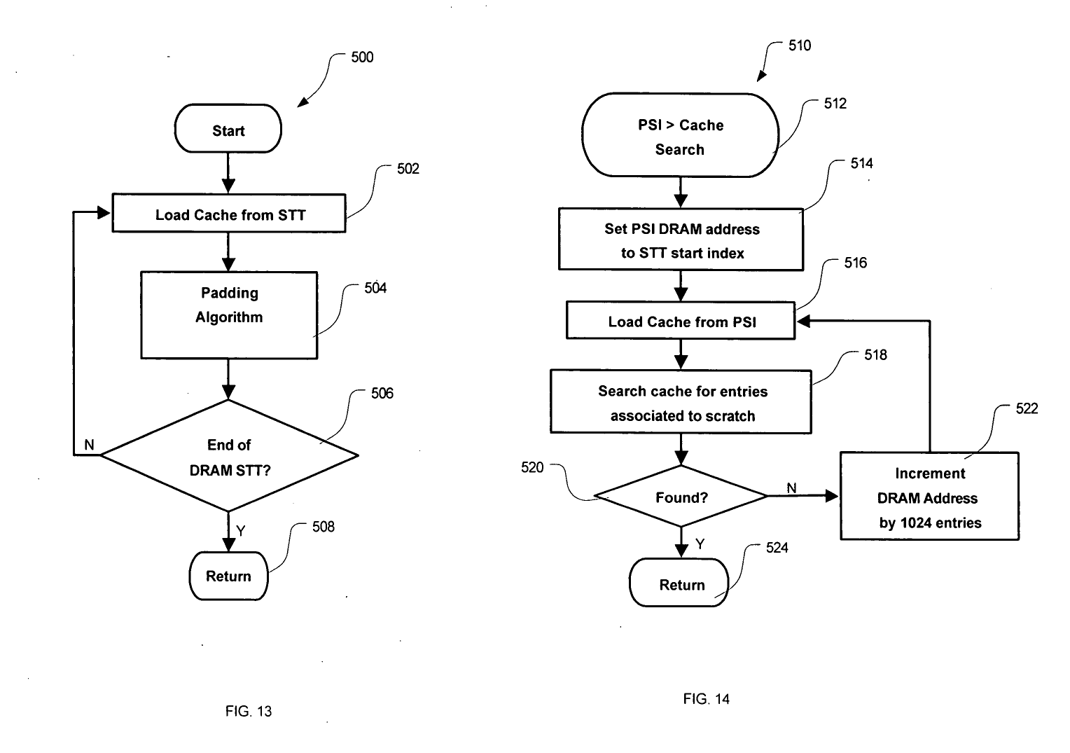

In the discussion that follows, it may be helpful to note that FIGS. 11 and 12 demonstrate the characterization algorithm 202 and FIGS. 13 and 14 demonstrate the overall padding algorithm 204 variations involving the use of caching.

Turning now to FIG. 11, the simplest use of a cache in an embodiment of the present invention is shown. This is the situation when there are less than 1024 entries in the P-List 212 and less than 256 entries in the STT 210. This involves P-List caching and is shown in routine 300 in FIG. 11. If the PSI table exceeds 1024 entries, PSI caching is performed as shown in FIG. 14. If the STT 210 exceeds 256 entries, STT caching is performed as shown in FIG. 12. If necessary, STT in the padding operations may also be cached, as shown in FIG. 13.

The method 300, involving P-List caching, is built on top of the characterization method as in the first embodiment described above with reference to FIG. 6. Operation 304 is in effect operation 202 with the entries loaded from the P-list cache instead of direct from the P-List 212 and the PSI entries updated to the PSI cache instead of direct to the PSI table 216. Operation 304 will also support caching of the STT that will be described later but not important in the description of the operations where the PSI and P-List are cached.

With this modification, the operations 302, 306, 308, 310 and 312 are just involved in loading the P-List entries 212 from the P-List to the cache and updating PSI entries 214 from the cache to the PSI Table 216. The operation 300 begins in operation 302 where the 1024 P-List entries are loaded to the cache. The P-List cache is then transferred to operation 304 which has been described in detail by operation 202 with the exception that the P-List entries are obtained from the cache and PSI entries are updated to the cache.

When operation 304 has completed for all the cached P-List entries, control is transferred to operation 306, that will determine if the end of the P-List in the DRAM has been reached. If the answer is no, control will transfer to operation 308 where the updated PSI entries are transferred to the PSI table 216 in DRAM before returning to operation 302 to load the P-List cache with the next 1024 entries from the DRAM. If the answer to the question in operation 306 is yes, control will be transferred to operation 310.

Operation 310 will determine if there are any PSI entries updated to the DRAM. If the answer is no, the PSI information will be used directly from the cache and no other operations is necessary and the control is returned to the calling function via operation 314. If the answer is yes, the PSI entries in the cache is updated to the PSI table 216 in DRAM before control is returned to the call function via operation 314. A different situation exists when the STT 210 exceeds 256 entries. In this case, all entries in the STT cache are saved to the DRAM and only active entries are kept in the TCM. In this case the STT cache is loaded from the DRAM starting with the first active entry. An active entry is defined as one with the cylinder of the last entry within the radial window of the current entry. This is because the P-List is arranged in an ascending order of cylinder, head and BFI. So, if the last entry of an STT is outside this window, it would never be active again. Thus each cached set of the full STT overlaps, but eliminates any need to include the inactive entries.

Briefly, the P-List entry is checked against the cache STT 210 as in operation 226, described above. If an update is possible, the relevant scratch is updated. If an update is not possible, the query is made whether or not it is the end of the STT 210. If not, load the new entry and repeat. If it is the end of the STT 210, a new scratch will be created in the STT and the cache information is updated. The entire STT in DRAM is then updated and the number of active STT entries is counted. If more than 256 entries are counted, the first active STT index is recorded. Otherwise, only active entries will be loaded into the cache.

Referring now to FIG. 12, characterization (as in operation 304 in routine 300) with STT caching is more fully explained. The routine 400 begins in operation 402 where the query is made whether the active STT 210 has more than 256 active entries. If the answer to query operation 402 is no, process control continues as in routine 300. In other words, control bypasses operation 404 and transfers to operation 406, where the P-List entry is checked against the cached STT 210 to determine whether the defect entry is within the predetermined window of any entry in the STT 210. If the answer to query operation 402 is yes, the active STT is greater than 256 entries, process control proceeds to operation 404 where the cache is loaded with those STT 210 active entries from DRAM, starting with the first active entry, and then control transfers to operation 406. Referring back to FIG. 8, for example, the radial window is 130 cylinders. The last current entry is 13 (2,368/0/242,298). Scratches 0 to 8 are inactive. Only STT Scratches 9 and 10 are active, thus only Scratches 9 and 10 would be loaded into the cache. Then control transfers to operation 408.

Query operation 408 asks whether an entry in the cache can possibly be updated. If the answer is no, no update is possible, control transfers to query operation 410. If an update is possible, control transfers to operation 414.

Query operation 410 asks whether the end of the active STT 210 has been reached. If the answer is yes, then control transfers to operation 412 where a new STT entry is generated, since an existing scratch can't be updated. If the answer in query operation 410 is no, there is more to the active STT 210, then control transfers back to operation 404, where the next set of the STT 210 entries is loaded into the cache. Then operations 406 and 408 and 410 are repeated until the end of the active STT 210 is reached, where control is passed to operation 412 then to operation 414 or if the answer to query 408 is yes, where control is passed straight to operation 414.

In the former instance, the operation is a “pass through” since the STT 210 was just updated by virtue of adding a new entry. Control then transfers to operation 416

Query operation 416 again asks whether there are more than 256 active STT entries. This query is necessary to determine if the new STT entry must be updated to the cache and then DRAM or if only an update to the cache is necessary. If the answer in query operation 416 is yes, then control transfers to operation 418, where the STT in DRAM is updated and the active STT count is updated. If the answer in query operation 416 is no, then control transfers to query operation 420.

Query operation 420 asks whether the STT cache is out of space. If not, control transfers to end operation 428, which transfers control back to the calling program. If the answer in query operation is yes, the STT cache is out of space, control transfers to operation 418. Again, in operation 418, the STT in the DRAM is updated and the active STT 210 count is updated. Note that the active STT may have shrunk if the end points of active STT entries passed beyond the radial window of the current P-List entry so that they are unable to form a scratch or part of a scratch with any subsequent P-List entries. Control then transfers to query operation 422.

Query operation 422 again asks whether the active STT is greater than 256. If so, control transfers to operation 426. If the answer in query opration 422 is no, control transfers to operation 424.

Operation 424 loads the active entries to the cache and control transfers to end operation 428, where control returns operation 304 for completion of the characterization algorithm, update of the PSI (operation 306) until the end of the P-List 212 is reached in operation 308. Operation 426, on the other hand, records the first active STT 210 entry index and then returns to the calling program 300 in operation 428, specifically operations 304-310.

The padding portion 500 of the method in accordance with the alternative embodiments of the invention involving caching are best understood while referring to FIGS. 13 and 14.

FIG. 13 shows the process 500 where caching has been utilized, such as where the STT 210 has greater than 256 entries. Here, operation begins in operation 502, where the cache is loaded from the STT 210. Control then transfers to padding algorithm operation 504 which implements the operations described previously, in operations 240 through 250 with reference to FIGS. 9 and 10 in which, for example, pads are added above, in between, and below the identified scratch. After each scratch in the cache is padded through this series of operations, control transfers to query operation 506, which asks whether the end of the DRAM STT has been reached. If not, control transfers to operation 502 where the next portion of the STT in DRAM is loaded and the padding process in operation 504 is repeated. Finally, when the end of the DRAM STT is reached, control passes to end operation 508 in which overall process control returns to the calling program.

The process 244 may be slightly different if the PSI table 216 is too large for the TCM, i.e., there are more than 1024 P-List entries. In this case, each time a request to search or update the PSI table 216 is made, such as the operation 244 where the PSI table 216 is searched, a routine 510 as is shown in FIG. 14 must be implemented.

Routine 510 begins in operation 512 in which the query is made whether the PSI table 216 is greater than the available cache size, and thus cannot be loaded all at once. If the PSI table 216 is less than the cache size, the PSI table 216 is already in the cache and process continues as above described. If the PSI table is to large, control passes to operation 514. In operation 514, the PSI DRAM address is set to the STT start index. Control passes to operation 516 where the first 1024 entries of the PSI table are transferred into the cache. Control then transfers to operation 518 where the cache is searched for entries associated with the scratch. Control then transfers to query operation 520. Query operation asks whether there are entries associated with a scratch found. If so, control transfers to return operation 524, in which control returns to the place in the routine asking for the PSI table 216, such as the operation 244 carried out in the padding routine operation 504 in routine 500. If, on the other hand, no matching entries were found in operation 518, control passes to operation 522. The DRAM addresses are incremented in operation 522 and the next 1024 entries in the DRAM PSI table are loaded into the cache and control returns through operation 516 to search operation 518. This process repeats until the required P-List entry is found.

Thus, for a disc drive 100 utilizing a limited buffer size, such as TCM, if the size of the P-List, the STT, and the PSI table are each too large to be immediately accommodated, e.g., several thousand, the process 200 may well involve use of each of the routines 300, 400, 500, and 510 described with reference to FIGS. 11 through 14 iteratively, in order to process all of the scratches identified on the disc media.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, the routines 200, 300, 400, 500 and 512 may be incorporated in drive firmware and/or may be externally controlled during the manufacture of the disc drive 100. The size of the scratches may be predefined or established by the user. Different padding schemes may be implemented other than the ones specifically described herein. Numerous other changes may be made which will readily suggest themselves to those skilled in the art and which are encompassed in the spirit of the invention disclosed and as defined in the appended claims.

1. A method of managing spatially related defects on a data storage media surface in a data storage device comprising:
identifying defect locations on the media surface;
determining whether the location of an identified defect is within a predetermined window of another identified defect location on the media surface;
if the location is within the predetermined window, characterizing the defects in the window as a scratch; and.
generating a scratch tracking table having a start index and an end index for each scratch.

2. The method according to claim 1 further comprising padding the scratch.

3. The method according to claim 1 wherein the characterizing operation comprises:
assigning a unique scratch index to the scratch; and
associating each defect within the window with the unique scratch index.

4. The method according to claim 3 further comprising:
generating a scratch index table associating each identified defect with a scratch index.

5. The method according to claim 1 wherein the determining operation comprises:
loading an identified defect location in a register; and
comparing the defect location and a last identified defect location of each identified scratch against predetermined window criteria.

6. The method according to claim 7 wherein the predetermined window criteria comprises a number of cylinders and a number of bytes.

7. A method comprising:
identifying defect locations on a data storage media;
tabulating the identified defects in a defect list;
determining whether one or more defect locations lies within a predetermined window of another defect location;
assigning a unique scratch index to each defect location within the predetermined window;
generating a scratch tracking table listing a start index for a first defect location in the window and an end index for a last defect location in the window for each scratch index assigned; and
generating a scratch index table associating a scratch index with each defect location.

8. The method according to claim 7 further comprising:
using the scratch tracking table and the scratch index table to determine whether a read or write command is to be redirected to another data storage media location.

9. The method according to claim 7 further comprising:
retrieving an entry in the scratch tracking-table having a first scratch index;
searching the scratch index table for defect locations associated with the first scratch index;
padding the scratch; and
repeating the retrieving, searching and padding operations for a next scratch index.

10. The method according to claim 9 wherein the repeating operation includes a query operation asking whether an end of the scratch tracking table has been reached prior to retrieving the next scratch index.

11. A system for managing scratches on a data storage media in a data storage device comprising:
a controller adapted to control access by a host to and from the data storage media;
a memory coupled to the controller;
a scratch index table in the memory having a unique index entry for each identified defect location on the data storage media and an associated scratch index entry for each defect location; and;
a scratch tracking table in the memory having, for each scratch index entry, a start index, and end index, and an end defect location for each identified scratch index.

12. The system according to claim 11 further comprising a buffer in the controller wherein the scratch tracking table and scratch index table are utilized in the buffer to identify defect locations.

13. The system according to claim 11 further comprising:
an operational sequence for identifying defect locations on the media surface;
an operational sequence for determining whether the location of an identified defect is within a predetermined window of another identified defect location on the media surface;
an operational sequence for characterizing the defects in the window as a scratch, if the location is within the predetermined window; and.
an operational sequence for generating a scratch tracking table having a start index and an end index for each scratch.

14. The system according to claim 13 further comprising an operational sequence for padding each scratch in the scratch tracking table.

15. The system according to claim 13 wherein the characterizing operational sequence comprises:
assigning a unique scratch index to the scratch; and
associating each defect within the window with the unique scratch index.

16. A data storage device comprising:
a data storage medium;
a controller coupled to the data storage medium;
a plurality of sequences for generating and using a scratch tracking table and a scratch index table to characterize defects identified on the data storage medium as belonging to one or more identified scratches.

17. The data storage device according to claim 16 further comprising a sequence for padding identified scratches on the medium.

18. The data storage device according to claim 16 wherein a sequence for generating a scratch tracking table includes operations of:
identifying defect locations on the data storage medium;
tabulating the identified defects in a defect list;
determining whether one or more defect locations lies within a predetermined window of another defect location;
assigning a unique scratch index to each defect location within the predetermined window; and
generating the scratch tracking table listing a start index for a first defect location in the window and an end index for a last defect location in the window for each scratch index assigned.

19. The data storage device according to claim 18 further comprising a sequence for generating a scratch index table associating a scratch index with each defect location.

20. The data storage device according to claim 19 further comprising a sequence for padding each scratch listed in the scratch tracking table.
